(19) United States
(12) Patent Application Publication
(10) Pub. No.: US 2025/0297728 A1
(43) Pub. Date: Sep. 25, 2025

(54) Detachable Lamp

(71) Applicant: Hangzhou Trendall International Trading Co., Ltd., Hangzhou (CN)

(72) Inventor: Li Zhang, Hangzhou (CN)

(21) Appl. No.: 18/955,930

(22) Filed: Nov. 21, 2024

(30) Foreign Application Priority Data
Mar. 25, 2024 (CN) 202420579590.7

(51) Int. Cl. F21V 21/02; F21V 23/06

(52) U.S. Cl. CPC F21V 21/02; F21S 6/002; F21V 21/06; F21V 23/06

(57) ABSTRACT

The application provides a detachable lamp comprising a lamp pole and a base that is detachably connected with the lamp pole, wherein the lamp pole has a first lighting unit and a first connecting unit located on the lamp pole, a second connecting unit connected with the first connecting unit of the lamp pole is formed in the base, and the second connecting unit comprises a second energizing subunit that is electrically connected with the first lighting unit of the lamp pole and a second plug-in subunit that is plugged with the first connecting unit and recesses into the base.

### TECHNICAL FIELD

The application relates to the field of lamps and, more specifically, to a detachable lamp.

### DESCRIPTION OF THE PRIOR ART

Traditional lamps are usually integrally formed, and after the lighting unit of a lamp is damaged, the entire lamp can only be scrapped, resulting in a waste of resources. The introduction of rechargeable and detachable bases tends to be more energy-efficient and environmentally friendly, and can significantly reduce the cost and environmental pollution generated during use.

For the lamp, the base and the lamp pole have a separable structure, and the bottom of the lamp pole and the base have connectors of copper piece which may be combined for electrical conduction. The base is equipped with a rechargeable battery and is compatible with the common Type-C charging port in the market. Through the configuration of key switches to control the LED bulb on the lamp pole, the cost of daily use of the product is greatly reduced and the interest of the product is improved.

### SUMMARY OF THE DISCLOSURE

An object of the application is to provide a detachable lamp. The detachable lamp has a detachable structure, so that the base and the lamp pole can be disassembled and connected as needed during use, and the detachable structure has good stability, avoiding the displacement of the lamp pole and the base during use.

In order to achieve the above object, a technical solution provided by the application is a detachable lamp comprising:
a lamp pole and a base that is detachably connected with the lamp pole, wherein the lamp pole has a first lighting unit and a first connecting unit located on the lamp pole, a second connecting unit connected with the first connecting unit of the lamp pole is formed in the base, and the second connecting unit comprises a second energizing subunit that is electrically connected with the first lighting unit of the lamp pole and a second plug-in subunit that is plugged with the first connecting unit and recesses into the base.

In one embodiment, the second plug-in subunit is a groove enclosed by a peripheral edge of the second energizing subunit and the base.

In one embodiment, a top surface of the second energizing subunit is provided with a socket for electrical connection with the first lighting unit of the lamp pole.

In one embodiment, the base comprises a circuit board, a charging unit electrically connected with the circuit board and a power port formed in the base.

In one embodiment, the base comprises a second lighting unit having a light strip.

In one embodiment, the base is made of translucent plastic.

In one embodiment, the first connecting unit is located at a bottom of the lamp pole.

In one embodiment, the second connecting unit is located at a top surface of the base.

In one embodiment, the lamp pole comprises a decorative portion.

In one embodiment, the first connecting unit comprises a first energizing subunit for electrical connection with the second energizing subunit and a first plug-in subunit for plugging into the groove.

The beneficial effects of the detachable lamp provided by the application are that: the detachable lamp has a detachable structure, so that the base and the lamp pole can be disassembled and connected as needed during use, and the detachable structure has good stability, avoiding the displacement of the lamp pole and the base during use.

### BRIEF DESCRIPTION OF DRAWINGS

To more clearly explain the technical solutions of the embodiments of the application, the drawings required for the description of the embodiments or the prior art are briefly introduced. It is obvious that the drawings below are only for some embodiments of the utility model. The ordinary technicians in the field can also obtain other drawings from these drawings without creative labor.

FIG. 1 is a perspective of the detachable lamp of the present application.

FIG. 2 is a perspective of the base of the detachable lamp of FIG. 1.

FIG. 3 is a top view of the base of the detachable lamp of FIG. 1.

FIG. 4 is a perspective of the lamp pole of the detachable lamp of FIG. 1.

FIG. 5 is a schematic diagram of the electrical connection inside the detachable lamp.

### REFERENCE SYMBOLS

1 Lamp pole, 11 First lighting unit, 12 First connecting unit, 120 First energizing subunit, 212 First plug-in subunit, 23 Decorative portion,
2 Base, 21 Second connecting unit, 211 Second energizing subunit, 212 Second plug-in subunit, 2111 Socket, 22 Circuit board, 26 Charging unit, 24 power port, 25 Second lighting unit.

### DESCRIPTION OF EMBODIMENTS

Embodiments of the present application are described in detail below, and examples of the embodiments are shown in the accompanying drawings, in which the same or similar numerals from beginning to end indicate the same or similar elements or elements having the same or similar functions. The embodiments described below by reference to the drawings are illustrative and are intended to be used in the interpretation of the application and should not be construed as limiting the present application.

In the description of the present application, it is to be understood that the terms “length”, “width”, “upper”, “lower”, “front”, “rear”, “left”, “right”, “vertical”, “horizontal”, “top”, “bottom”, “inner”, “outer”, etc., indicate orientations or positional relationships based on the orientations or positional relationships shown in the drawings and are for convenience of description and simplification of description, and do not indicate or imply that the device or element referred to must have a particular orientation, be constructed and operated in a particular orientation, Therefore, it cannot be construed as limiting the present application.

In the description of the present application, unless otherwise expressly specified or limited, the terms “mount”, “couple”, “connect” and “fix” and so on, should be understood broadly, e.g., they may be fixedly connected, detachably connected, or integrally connected; They may be mechanically or electrically connected; They may be directly connected or indirectly connected through an intermediate medium, and may be the internal connection of two elements or the interaction relationship between two elements. For a person of ordinary skill in the art, the specific meaning of the above terms in the present application can be understood by the specific circumstances.

It should be noted that the terms “first”, “second”, etc., in the description, claims and drawings of the present application, are used to distinguish similar objects, and are not necessarily used to describe a particular order. It should be understood that the data so used are interchangeable where appropriate so that the embodiments of the present application described here can be implemented in an order other than those illustrated or described here. In addition, the terms “comprising” and “having” and any variation thereof are intended to cover non-exclusive inclusions, e.g., a process, method, system, product or apparatus comprising a series of steps or elements need not be limited to those steps or elements that are clearly listed, but may include other steps or elements that are not clearly listed or are inherent to those processes, methods, products or equipment.

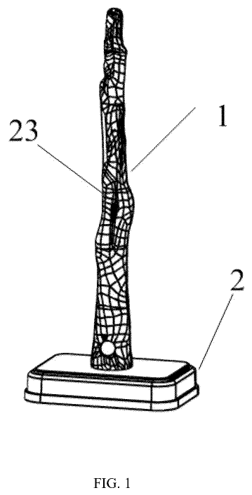

As shown in FIG. 1, the detachable lamp comprises a lamp pole 1 and a base 2 that is detachably connected with the lamp pole 1, and the lamp pole 1 has a decorative portion 23. The light pole 1 is detachable when not in use, which is convenient for storage and saves space. The decorative portion 23 can be set into various shapes with aesthetic effects, for example, the decorative portion 23 can be set as a tree trunk.

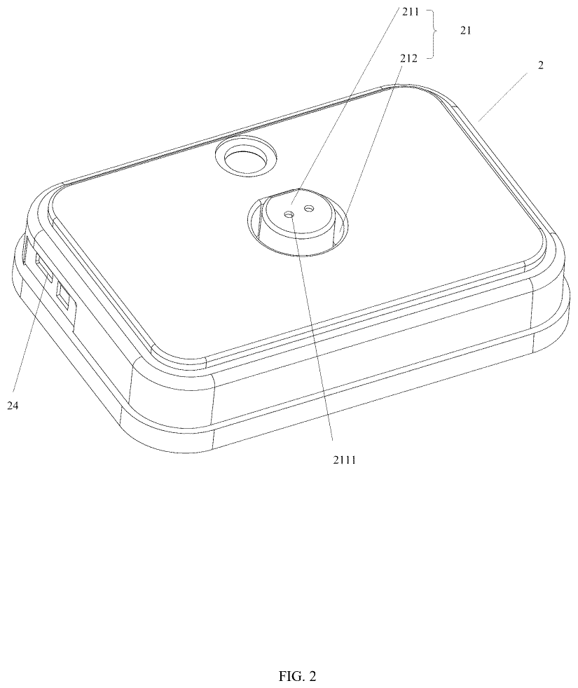

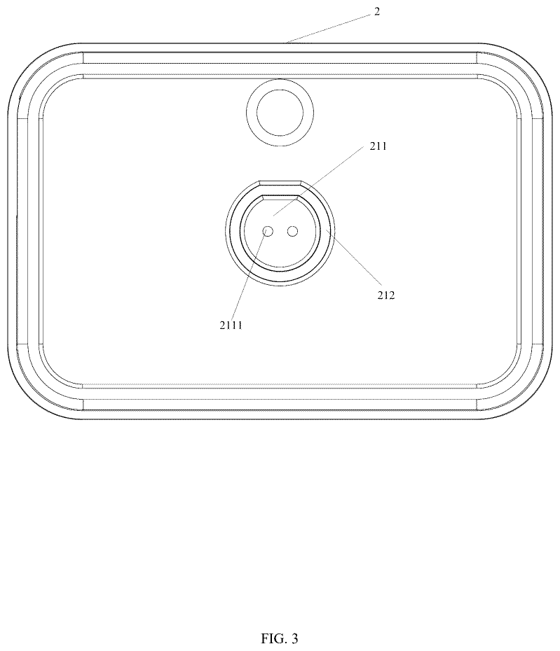

As shown in FIG. 2 and FIG. 3, a second connecting unit 21 connected with the lamp pole 1 is formed in the base 2, and the second connecting unit 21 comprises a second energizing subunit 211 that is electrically connected with the lamp pole 1 and a second plug-in subunit 212 that is plugged with the lamp pole 1 and recesses into the base 2. The second plug-in subunit 212 is a groove enclosed by a peripheral edge of the second energizing subunit 211 and the base 2.

As shown in FIGS. 1-5, the lamp pole 1 has a first lighting unit 11 and a first connecting unit 13 located on the lamp pole 1, a second connecting unit 21 connected with the first connecting unit 12 of the lamp pole 1 is formed in the base 2, and the second connecting unit 21 comprises a second energizing subunit 211 that is electrically connected with the first lighting unit 11 of the lamp pole 1 and a second plugging subunit 212 that is plugged with the first connecting unit 12 and recesses into the base 2. Wherein, preferably, the first connecting unit 12 is located at the bottom of the lamp pole 1, and the second connecting unit 21 is located at the top surface of the base 2. Of course, the positions of the first connecting unit 12 and the second connecting unit 21 can also be changed according to the actual situation, and they are not limited here.

As shown in FIGS. 1-5, the first connecting unit 12 comprises a first energizing subunit 120 for electrical connection with the second energizing subunit 211 and a first plug-in subunit 121 for plugging into the groove. The first energizing subunit 120 and the second energizing subunit 211 can be one of a copper buckle and a copper sleeve that can be plugged into each other, wherein the copper sleeve is used for the copper buckle to be embedded in.

As shown in FIG. 2 and FIG. 3, a top surface of the second energizing subunit 211 is provide with a socket 2111 for electrical connection with the first lighting unit 11 of the lamp pole 2. The first energizing subunit 120 can be plugged into the socket 2111.

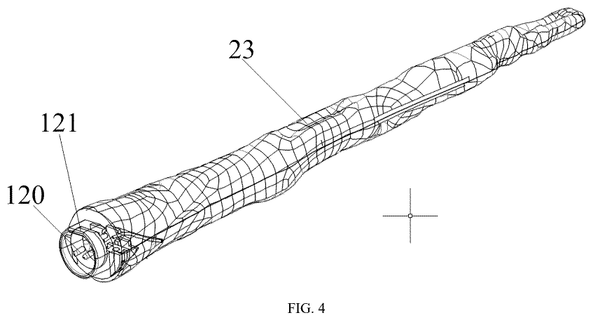

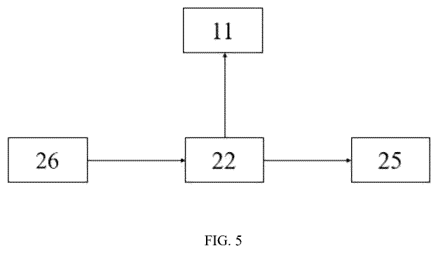

As shown in FIG. 4 and FIG. 5, the base 2 has a circuit board 22, a charging unit 26 electrically connected to the circuit board 22 and a power port 24 formed in the base 2, and the power port 24 may be a USB port or other ports that can be used for power supply access.

As shown in FIG. 5, the base 2 may have a second lighting unit 25 which may be a light strip. The base 2 is made of translucent plastic. When the light strip is turned on, the light will seep out from the inside of the base 2, making the base 2 produce an aesthetic effect.

As shown in FIG. 5, the charging unit 26 is electrically connected with the circuit board 22. The charging unit 26 supplies power to the first lighting unit 11 and the second lighting unit 25. The charging unit 26 can be a battery for charging.

The foregoing are only some better embodiments of the present application and are not intended to limit the present application, and any modifications, equivalent substitutions and improvements, etc., made within the spirit and principles of this application shall be included in the scope of protection of this application.

What is claimed is:

1. A detachable lamp comprising:
a lamp pole and a base that is detachably connected with the lamp pole, wherein the lamp pole has a first lighting unit and a first connecting unit located on the lamp pole, a second connecting unit connected with the first connecting unit of the lamp pole is formed in the base, and the second connecting unit comprises a second energizing subunit that is electrically connected with the first lighting unit of the lamp pole and a second plug-in subunit that is plugged with the first connecting unit and recesses into the base.

2. The detachable lamp of claim 1, wherein the second plug-in subunit is a groove enclosed by a peripheral edge of the second energizing subunit and the base.

3. The detachable lamp of claim 1, wherein a top surface of the second energizing subunit is provided with a socket for electrical connection with the first lighting unit of the lamp pole.

4. The detachable lamp of claim 1, wherein the base comprises a circuit board, a charging unit electrically connected with the circuit board and a power port formed in the base.

5. The detachable lamp of claim 1, wherein the base comprises a second lighting unit having a light strip.

6. The detachable lamp of claim 5, wherein the base is made of translucent plastic.

7. The detachable lamp of claim 1, wherein the first connecting unit is located at a bottom of the lamp pole.

8. The detachable lamp of claim 7, wherein the second connecting unit is located at a top surface of the base.

9. The detachable lamp of claim 1, wherein the lamp pole comprises a decorative portion.

10. The detachable lamp of claim 2, wherein the first connecting unit comprises a first energizing subunit for electrical connection with the second energizing subunit and a first plug-in subunit for plugging into the groove.
